(19) United States
(12) Patent Application Publication
(10) Pub. No.: US 2009/0316705 A1
(43) Pub. Date: Dec. 24, 2009

(54) Quality of Service in Vlan-Based Access Networks

(76) Inventor: Wei Zhao, Stockholm (SE)

Correspondence Address: NIXON & VANDERHYE, PC, 901 NORTH GLEBE ROAD, 11TH FLOOR, ARLINGTON, VA, 22203, US

(21) Appl. No.: 11/922,388

(22) PCT Filed: Jun. 20, 2005
(86) PCT No.: PCT/EP2005/006634

§ 371 Date: Aug. 17, 2009

(51) Int. Cl. H04L 12/56

(52) U.S. Cl. 370/395.53

(57) ABSTRACT

In a broadband access network multiple end users connected to access nodes are linked to multiple service providers connected to an edge node. Packet transmitted across the network contain a quality of service identifier specifying a relative QoS or priority or an absolute QoS, defining minimum quality of service parameters required for handling the packet. The access network is preferably divided into separate virtual local area networks (VLANs) providing separate broadcast domains for the various end users. Each packet transmitted on the access network is VLAN-tagged with QoS identifier contained in this tag. When an access node or edge node receives an incoming data unit that specifies an absolute quality of service, the node determines that there is sufficient bandwidth through the access network to the destination node by querying other nodes in the network directly or indirectly through a bandwidth broker before accepting the service and transmitting the packet.

### FIELD OF INVENTION

The present invention relates to the support of multi-service traffic over VLAN-based access networks and has specific relevance to broadband Ethernet VLAN-based access networks

### BACKGROUND ART

There is currently a move to provide so-called triple-play services (voice, video and data) to end-users connected to broadband access networks. However, bandwidth in such access networks is never unlimited and the new emerging services require higher bandwidth than conventional best-effort services such as Internet surfing. For example, a single Internet protocol television (IPTV) channel requires on average 5 Mbps for a satisfactory result. High definition television (HDTV) has a still higher bandwidth requirement. With bandwidth demands of this kind, even Ethernet based access networks may experience a bandwidth shortage, let alone the massively deployed xDSL infrastructure. Since bandwidth is likely to remain a relatively scarce resource in the access network, an effective quality of service mechanism is essential.

A further factor is the current trend is to provide multi-operator, multi-provider and multi-service over the same broadband access network. In such a network, a well defined quality of service mechanism is not only necessary to provide end users with the services they pay for, but also is an important way for operators and providers to keep track of customers and generate revenues.

One scheme for supporting the multi-provider, multi-service model over the same physical broadband network involves the use of an Ethernet access network uses virtual local area network (VLAN) technology to ensure traffic separation. The Ethernet frame within the access network is provided with a VLAN tag. A 3-bit field within this tag is used to specify the relative user priority of the service compared to other services. The traffic is then handled according to its specified priority in accordance with IEEE802.1D. However, this type of handling does not guarantee sufficient bandwidth for all services available via the access network.

There is thus a need to provide a scheme that can provide the bandwidth necessary to some services to support true multi-service operation via the same physical access network.

### SUMMARY OF THE INVENTION

It is thus an object of the present invention to provide a method and apparatus to enable a broadband access network to support multi-service operation with a wide range of services including those with large bandwidth requirements.

This and further objects are achieved in accordance with the invention defined in the appended claims.

In essence the invention encompasses a broadband access network connecting multiple end users with multiple service providers. End users are connected to the access network via access nodes. The service providers are connected to the access network by an edge node. Each packet transmitted across the access network contains a quality of service identifier specifying at least one of a number of relative qualities of service, which imply a relative priority of the data unit, or at least one of a number of absolute qualities of service, which defines minimum quality of service parameters required for handling the packet. The access network is preferably divided into separate virtual local area networks (VLANs) providing separate broadcast domains for the various end users. Each packet transmitted on the access network is VLAN tagged, i.e. includes information identifying the VLAN together with related control information. The quality of service identifier is contained in a bit field included in this control information. When an access node or edge node receives an incoming data unit that specifies an absolute quality of service, the node determines that there is sufficient bandwidth through the access network to the destination node before accepting traffic forming part of this service and transmitting the packet.

In order to determine the bandwidth limitation across the network, or the specific VLAN, the node checks the bandwidth on the outgoing link and then requests information about links between the other nodes within the access network, preferably those within the segment between the access node and access edge node generated by the spanning tree protocol STP within the VLAN. This information is preferably provided by a centralised bandwidth broker that can access and obtain information form all nodes within the access network.

Since both absolute and relative quality of service identifiers are contained in the packets and extracted by the access nodes, these nodes are able to distinguish those services having strict quality of service parameters from other services and thus provide a guaranteed quality of service. Particularly for Ethernet-based access networks, which are connectionless in nature as are IP networks at the service providers this is essential to provide real triple-play multi-services to customers. The claimed solution also allows multiple service providers to coexist in the same access network, each offering their own specific QoS to their customers. Since services with absolute quality of service can be identified, different accounting methods may be applied to other services offered.

When a control field in the VLAN tag is used to identify the QoS parameters, this avoids the introduction of extra traffic overheads. All devices in the layer 2 aggregation network can use standard off-the-shelf switches. Moreover, since the link segment between an access node and access end node in a single VLAN is generated by the spanning tree protocol STP no extra path finding mechanism is needed. If bandwidth is reserved for absolute quality of service services there is no need for hop-to-hop resource reservation. This solution can thus work with as many services as the access network is capable of supporting.

### BRIEF DESCRIPTION OF THE DRAWINGS

Further objects and advantages of the present invention will become apparent from the following description of the preferred embodiments that are given by way of example with reference to the accompanying drawings. In the figures:

FIG. 1 schematically depicts a broadband access network in accordance with the present invention.

FIG. 2 depicts the structure of a VLAN-tagged Ethernet frame, and

FIG. 3 is a flow diagram illustrating the admission control for services practiced by nodes in the access network.

### DETAILED DESCRIPTION OF THE DRAWINGS

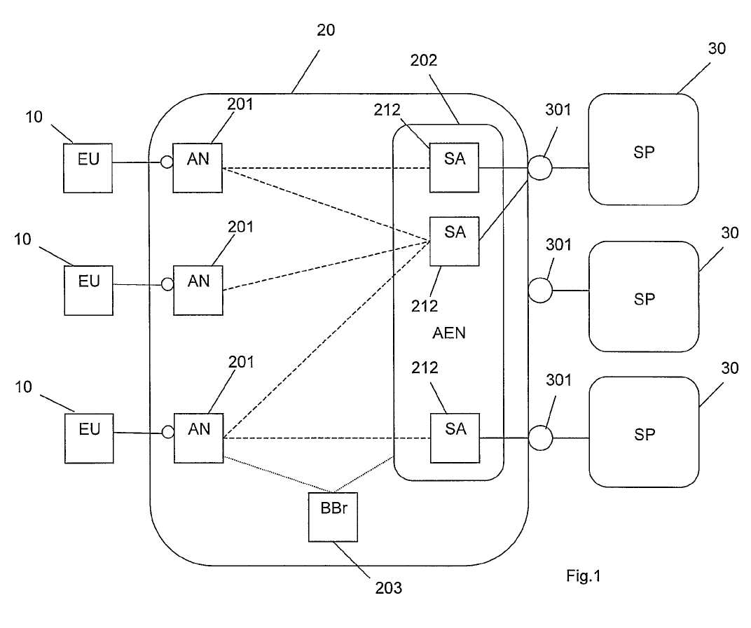

FIG. 1 schematically depicts the structure of a broadband access network connecting a plurality of end users with a plurality of service providers. In accordance with the preferred embodiment of the invention, the access network is an Ethernet-based network. The end users EU 10 may include individual devices or a local network of devices. Each end user 10 is connected to the access network 20 via a user port of an access node 201. A number of service providers SP 30 are also connected to the access network 20 via provider ports 301. The service providers may be network service providers providing access to a multitude of different services via other private or public networks including the Internet, or application service providers. The service providers SP 30 are connected to the access network AN 20 via at least one access edge node AEN 202. The access edge node AEN 202 or a group of these represent a complex that hosts a number of logical entities called service agents SA 212 set up by the service providers SP 30. Each service agent SA 212 maps the service primitives of a network or application context offered by a service provider to the transport primitives of the broadband access network towards the end users.

In the access network 20, the connection between an end user device EU 10 and a service provider SP 30 is given by a service binding represented by the dashed lines in FIG. 1. Each service binding is maintained by a service agent SA 212. A service provider SP 30 may have only one service agent SA 212 in the access network as illustrated by the single service binding at the lowermost half of FIG. 1. Alternatively, some service providers SP 30 may use more than one service agent SA 212, leading to multiple service bindings as shown in the uppermost portion of FIG. 1. However, different service providers do not user the same service agent SA 212.

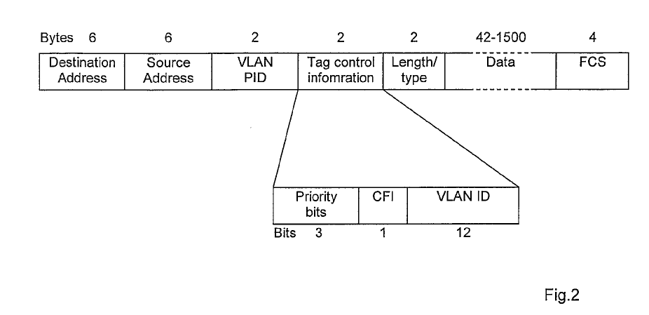

The access network is also divided into several virtual local area networks VLANs with one service agent SA 212 corresponding to a single VLAN. The separation of traffic into different VLANs requires the Ethernet frames to be tagged with VLAN identifiers and control information. The VLAN tag serves to identify membership of the frame to a particular VLAN, enabling it to be transmitted further within the associated VLAN or blocked by those network nodes belonging to a different VLAN. A tagged Ethernet frame is illustrated in FIG. 2. The standard fields are the destination address, source address, Length/type field, data and FCS bytes. The VLAN tag consists of a 2-byte VLAN tag protocol identifier (PID) and 2 bytes of tag control information. The tag control information is divided into a 3-bit field of priority information, a single bit flag canonical format indicator CFI, which is always set to zero for Ethernet switches and a 12-bit VLAN identifier. The purpose and use of these fields is well known in the art and is also defined in the IEEE 802.1P, IEEE 802.1D and IEEE 802.1Q specifications so will not be described in further detail here.

In accordance with the invention, the 3-bit priority field (p-bits) defined in the IEEE 802.1D specification is modified to permit a service to define absolute qualities of service QoS in addition to relative QoS or relative priorities. An absolute QoS defines a set of parameters, such as the required bandwidth and maximum tolerated packet delay that must be supported by a network. Accordingly, if a network can provide the specified parameters, the packets belonging to this service will be accepted. Conversely if a network or network segment is unable to provide the specified resources and handling, the service will be rejected. In contrast, relative QoS specifies only the relative importance of a service by priority. Services with a higher priority will be treated more favourably than those having a lower priority, however, no minimum resources are guaranteed for of these services. Accordingly, the quality may vary depending on the network status.

The first of the three p-bits serves to distinguish between absolute and relative QoS classes. Specifically if absolute QoS support is required the first bit is set to 1, yielding the bit pattern 1xx, while if only relative priority is required the first bit is set to zero, resulting in the bit pattern 0xx. The remaining two bits in the p-bit field allow four separate absolute QoS classes with different defined values for bandwidth, packet delay, etc. and four relative QoS classes with different levels of priority, respectively.

The quality of service required for any particular service may be the subject of a negotiation between an end user EU 10 and a service provider SP 30, possibly as a function of different billing rates. Alternatively, it may be specified by a third party device. If the resulting quality of service is an absolute QoS, packets or frames belonging to this service will receive the 1xx bit values closest to the specification. Similarly, if the resulting quality of service is a relative priority, the frames will include the most appropriate 0xx p-bit value. The filling of the p-bit field is performed at the access edge node AEN 202 for downstream traffic and by a residential gateway, or similar device at the end user EU 10 for upstream traffic.

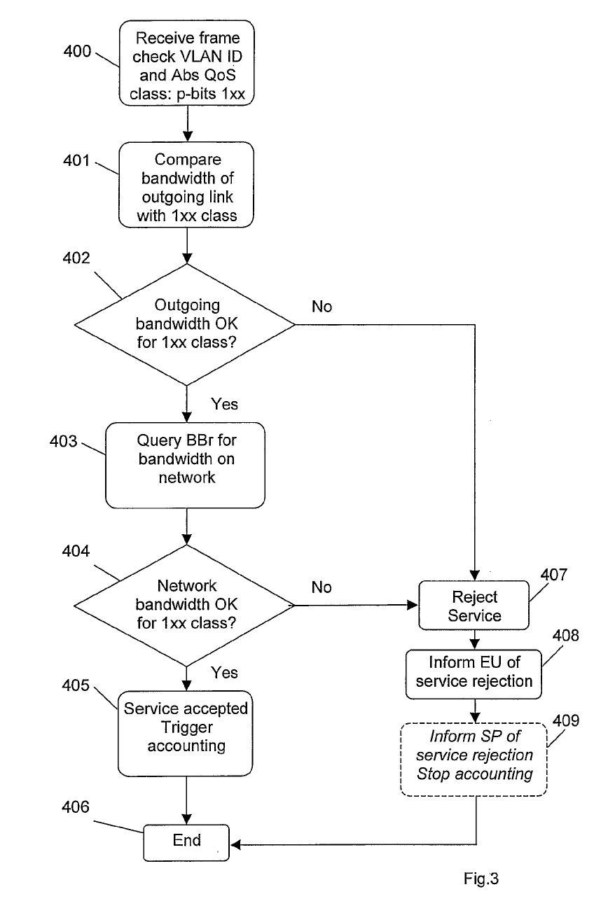

In order to support services with absolute QoS, the access nodes AN 201 and access edge node AEN 202 must determine whether to admit a service to the access network. This means that on receipt of a frame for a new service specifying absolute bandwidth and packet delay requirements, the nodes must determine whether sufficient bandwidth is present in the access network to support this service. This is achieved in part with the aid of a bandwidth broker in the access network 20. As shown in FIG. 1 the bandwidth broker BBr 203 is a separate centralised entity that has knowledge of the access network topology and is accessible by all nodes in the access network 20. The bandwidth broker BBr 203 may be a dedicated node in the access network 20 or a server located in or near the access network with direct or indirect links to all nodes. The bandwidth broker BBr 203 may include or have access to a database containing the current network topology and in particular the STP segments between the access nodes 201 and access edge node 202. Although only two connections are illustrated with dotted lines between the bandwidth broker BBr 203 and an access node AN 201 and the access edge node AEN 202 it will be understood that the bandwidth broker BBr 203 is able to communicate with all nodes in the access network 20. The operation of the various access nodes AN 201 and the access edge node AEN 202 in controlling admission to the network 20 of services requiring an absolute quality of service will be described with reference to the flow diagram in FIG. 3.

In FIG. 3 the steps of the algorithm surrounded by unbroken lines is performed both by access nodes AN 201 for upstream traffic, i.e. traffic from and end user EU 10 to a service provider SP 30 and by the access edge node AEN 202 for downstream traffic, i.e. traffic from a service provider SP 30 to an end user EU 10. The part of the algorithm shown in broken lines is performed only by the access edge node AEN 202 for downstream traffic. The algorithm starts at step 400 with the receipt of the access node AN or access end node AEN of a data packet or frame with the correct VLAN identification and with a p-bit pattern 1xx specifying one of the absolute QoS classes. At step 401 the node determines the parameters associated with the specified QoS class, checks its outgoing link towards the access network associated with the VLAN to determine the available bandwidth and compares this with the specified bandwidth requirement at step 402. If the available bandwidth is insufficient, the method moves on to steps 407 and 408: the service is rejected and the end user is informed of the service rejection. If the bandwidth on the outgoing link is sufficient for the specified QoS the method moves on to step 403 and the node sends a request to the bandwidth broker BBr 203 asking for the available bandwidth inside the network. The bandwidth broker BBr 203 queries the switches included in the tree segment from the requesting node to the final node at the edge of the access network i.e. towards the access edge node AEN 202 for upstream traffic and towards an access node AN 201 for downstream traffic, for the available bandwidth, and subsequently returns a message to the requesting node indicating the minimum available bandwidth. At step 404 the node compares the minimum available bandwidth communicated by the bandwidth broker BBr 203 with the bandwidth requirement specified by the 1xx bit pattern and if it is inadequate the method moves to steps 407 and 408 with the node rejecting the service and informing the end user EU 10 of this fact. If, however, the minimum bandwidth communicated by the bandwidth broker BBr 203 is sufficient to support the required QoS, the method passes on to step 405 and the service is accepted and accounting is triggered.

When this algorithm is performed by the access edge node AEN 202 for downstream traffic the rejection of the service at step 407 is followed by the access edge node AEN informing both the end user EU at step 408 and additionally the service provider SP at step 409 and also in triggering the stop of accounting.

Once a service that specifies an absolute QoS has been accepted onto the network, both the access nodes AN 201 and the access edge node AEN 202 perform conventional rate limiting and policing for subsequent packets or frames relating to the same service.

Traffic that specifies relative QoS is handled in the same way as in conventional networks. No admission control is needed. The access nodes AN and access edge node AEN let in as much traffic as possible and handle the traffic in accordance with the four different priority classes specified by the 0xx p-bit pattern.

Turning again to FIG. 1 it will be appreciated that the mix of traffic on any particular VLAN will depend upon the number of service agents 212 available for each service provider SP 30. When a service provider SP 30 has only one service agent in the access network 20 the VLAN must carry a mix of absolute and relative QoS traffic.

Depending on whether a service provider SP 30 sets up one or several service agents SA 212, services with absolute QoS and relative QoS can either go into the same VLAN or into separate VLANs. If a single VLAN carries both absolute and relative QoS frames, all nodes or switches within this VLAN will reserve a certain absolute amount of bandwidth or a fixed percentage of the bandwidth for services having absolute QoS. Since link capacities are often different on different nodes, with the link bandwidth limited by the link having the lowest bandwidth it is preferable for nodes to reserve an absolute amount of bandwidth rather than a percentage. Relative QoS traffic is handled in the conventional manner with normal policing and queuing algorithms. For Absolute QoS traffic the access node AN 201 or access edge node AEN 202 performs the admission control algorithm illustrated in FIG. 3.

If the service provider SP 30 has a separate service agent SA 212 for each of the services it provides, there will be no mix of traffic in the different VLANS. However, in those VLANs handling absolute QoS traffic the admission control algorithm of FIG. 3 will be implemented.

Another possibility is for a service provider SP 30 to use one VLAN for relative QoS traffic of different service types and another VLAN for absolute QoS traffic. Here again admission control of the absolute QoS traffic must be performed by the access and access edge node in the relevant VLAN.

In the preferred embodiment described above, the bandwidth broker BBr 203 is a centralized entity in the access network. However, the bandwidth determination function could alternatively be distributed among the nodes in the access network. In this case each node in the access network would broadcast its available resources in a distributed manner.

1. An access node in a packet-switched broadband access network connecting a plurality of end users to a plurality of service providers, said node being adapted to identify a quality of service identifier in received packets belonging to a specific service destined for an end user or a service provider, wherein said node is further adapted to ascertain that said quality of service identifier specifies absolute quality of service parameters, to determine the available bandwidth across the network towards the destination end user or service provider, and to accept the service and transmit the packet on the access network only if the available bandwidth is sufficient to provide the quality of service parameters specified in said quality of service identifier.

2. An access node as claimed in claim 1, wherein said access node is arranged in a virtual local area network in said access network and wherein said node is adapted to extract said quality of service identifier from a virtual local area network tag incorporated in said packet and to determine the bandwidth between nodes contained in a spanning tree protocol segment within said virtual local area network towards the destination end users or service provider.

3. An access node as claimed in claim 2, wherein said node is adapted to determine the minimum bandwidth available on an outgoing link associated with the virtual local area network and to request bandwidth information from other nodes in said spanning tree protocol segment within the virtual local area network to determine the minimum available bandwidth towards the destination end user or service provider.

4. An access node as claimed in claim 3, wherein said access node is adapted to request information from said other nodes in said spanning tree protocol segment via a separate bandwidth broker accessible to nodes in said access network.

5. An access node as claimed in claim 1, wherein said node is connected to at least one service provider and provides access to said access network for said at least one service provider, wherein said node is further adapted to insert a quality of service identifier within a virtual local area network tag into an incoming packet belonging to a specific service.

6. A packet-switched broadband access network connecting a plurality of end users to a plurality of service providers via a plurality of switching nodes, said access network including a plurality of access nodes connected to said end users and adapted to provide access to said access network for said end users and at least one access edge node connected to said plurality of service providers and adapted to provide access to said access network for said service providers, said access network further being divided into a plurality of virtual local area networks linking one service provider and at least one end user, wherein each of said access nodes and access edge node is adapted to verify a virtual local area network tag contained in received packets, wherein each of said access nodes and access edge node is further adapted to identify whether a quality of service identifier contained in said virtual local area network tag in said received packets specifies absolute quality of service parameters or a relative quality of service, to ascertain that said quality of service identifier specifies absolute quality of service parameters applicable to packets belonging to a specific service, to determine the available bandwidth via switching nodes within the virtual local area network towards the destination end user or service provider, and to accept the service and transmit the packet on the access network only if the available bandwidth is sufficient to provide the quality of service parameters specified in said quality of service identifier.

7. An access network as claimed in claim 6, further characterized by a bandwidth broker adapted to communicate with all nodes in said access network, to obtain bandwidth information about outgoing links from said nodes and to communicate the minimum available bandwidth on a spanning tree protocol segment to a requesting access or access edge node.

8. An access network as claimed in claim 6, wherein said access network is an Ethernet-based network.

9. In a broadband packet-switched access network connecting a plurality of end users to a plurality of service providers via a plurality of switching nodes, wherein said access network includes a plurality of access nodes connected to said end users and at least one access edge node connected to said plurality of service providers, a method of controlling access to said access network in an access node or said access edge node including the steps of identifying a service identifier in received packets belonging to a specific service destined for an end user or a service provider, ascertain whether said quality of service identifier specifies absolute quality of service parameters or a relative quality of service, determining the available bandwidth across the network towards the destination end user or service provider, and accepting the service and transmitting the packet on the access network only if the available bandwidth is sufficient to provide the quality of service parameters specified in said quality of service identifier.

10. A method as claimed in claim 9, wherein the step of determining the available bandwidth includes the step of determining the bandwidth on an outgoing link from said access node or said access edge node and requesting information on the available bandwidth between nodes in a specific segment within said access network towards the destination end user or service provider from said nodes.

11. A method as claimed in claim 9, wherein the step of determining the available bandwidth includes the step of determining the bandwidth on an outgoing link from said access node or said access edge node and requesting information on the available bandwidth between nodes in a specific segment within said access network towards the destination end user or service provider from a centralised centralized bandwidth broker.

12. A method as claimed in claim 10, further characterized by dividing the access network into a plurality of virtual local area networks with each local area network providing access to one service provider and at least one end user, wherein the step of requesting information on the available bandwidth from nodes in a specific segment includes requesting bandwidth information from nodes within a spanning tree protocol segment contained in a virtual local area network defined in said received packet.

13. A method as claimed in claim 9, further including the step of triggering the accounting of a service between an end user and a service provider when said service is accepted.

14. A method as claimed in claim 9, further including the step of rejecting a service if the available bandwidth is insufficient to provide the quality of service parameters specified in said quality of service identifier and informing at least the source or destination end user of said packet of the service rejection.

15. A method as claimed in claim 14, further including the step of informing the source service provider of a packet of the service rejecting and triggering the halting of accounting for said service between an end user and said service provider.
